(19) United States
(12) Patent Application Publication
(10) Pub. No.: US 2011/0259676 A1
(43) Pub. Date: Oct. 27, 2011

(54) WEAR AND FRICTION CONTROL OF METAL ROPE AND SHEAVE INTERFACES

(75) Inventors: Aaron T. Nardi, East Granby, CT (US); James T. Beals, West Hartford, CT (US); Wayde R. Schmidt, Pomfret Center, CT (US); Gregory S. Welsh, Vernon, CT (US); Mark Steven Thompson, Tolland, CT (US)

(73) Assignee: OTIS ELEVATOR COMPANY, Farmington, CT (US)

(21) Appl. No.: 13/141,720

(22) PCT Filed: Dec. 23, 2008
(86) PCT No.: PCT/US2008/013994

§ 371 Date: Jun. 23, 2011

(51) Int. Cl. B66B 15/04

(52) U.S. Cl. 187/250

(57) ABSTRACT

A coated sheave (24) for use in an elevator system in having at least one rope (22) and sheave combination, where the sheave has a predetermined shape and size for engagement with at least one rope in the elevator system. A coating (27) on the sheave has a wear coefficient of at least 80% less than the wear coefficient of the sheave without the coating.

### BACKGROUND

The present invention relates to elevator systems and more particularly to sheaves for such elevator systems.

A conventional traction elevator system typically includes a car, a counterweight, two or more tension members (such as round ropes) interconnecting the car and counterweight, a traction sheave to move the ropes, and a machine to rotate the traction sheave. The machine may be either a geared or gearless machine. A geared machine permits the use of a higher speed motor, which is more compact and less costly, but requires additional maintenance and space.

The ropes (whether the ropes for the car and counterweight or for the overspeed governor) can be formed from laid or twisted steel wire and the sheave (whether the drive sheave, deflector sheave or governor sheave) can be formed from cast iron. Differential tension on each side of the sheave, or rope deformation due to the tension applied, or misalignment of the sheave, can all cause relative motion between the rope and the sheave. The contact plus relative motion results in wear of the sheave and wire rope. Additionally, in the overspeed governor situation, the sheave may be used for applying significant tension to the rope to actuate the safeties on the elevator. This function requires controlled friction between the sheave and the rope.

Large fraction sheaves are often made from cast iron and can sometimes exhibit excessive wear in use. The sheaves function in combination with ropes that raise and lower elevator cars in various elevator systems such as those where the elevator car is supported by hoist ropes that are driven by a hoist motor. Elevator systems may also employ a counterweight at the opposite end of the hoist ropes. An example of an elevator system having a counterweight is described in commonly owned U.S. Pat. No. 3,610,342.

Although conventional round steel ropes and cast iron sheaves have proven very reliable and cost effective, there are limitations on their use. One such limitation is the traction forces between the ropes and the sheave. These traction forces may be enhanced by increasing the wrap angle of the ropes or by undercutting the grooves in the sheave. Both techniques reduce the durability of the ropes, however, as a result of the increased wear (wrap angle) or the increased rope pressure (undercutting). Another method to increase the traction forces is to use liners formed from a synthetic material in the grooves of the sheave. The liners increase the coefficient of friction between the ropes and sheave while at the same time minimizing the wear of the ropes and sheave.

Another factor in the use of round steel ropes is the flexibility and fatigue characteristics of round steel wire ropes. Elevator safety codes today require that each steel rope have a minimum diameter and that the Did ratio for traction elevators be greater than or equal y (D/d≧40), where D is the diameter of the sheave. The larger the sheave diameter D, the greater torque required from the machine to drive the elevator system. Consequently, the greater the torque, the more friction becomes a limiting factor in the operation of the elevator. Accordingly, there is a need to provide sheaves that are more resistant to friction and thereby reduce the wear coefficients on the surfaces of these elevator system components.

While ropes and other friction elements in elevator systems can be modified, by a variety of methods including material selection, methods of braiding or otherwise forming a rope, and coating the rope with a friction resistant material, there has not been improvement in the friction resistance and wear experienced by sheaves.

### SUMMARY

The invention relates to a sheave device and method for making it. The sheave device is designed for use in an elevator system having at least one sheave in combination with a rope or other moving friction element of the elevator system. The present invention places a coating on the sheave body on at least the portion of the sheave body that is to engage the friction element. The coating provides a wear coefficient on the sheave body of less than 2.0×10⁻¹⁰ mm²n and more preferred are wear coefficients of less than 1.0×10⁻¹⁰ mm²n. This results in a reduction in wear coefficient of about 20% to 10% of the wear coefficient of the sheave without a coating (i.e., over 80% to 90% reduction). The coating and sheave body together may need to be sized to maintain the predetermined shape and size of the sheave prior to coating.

### BRIEF DESCRIPTION OF THE DRAWINGS

FIG. 1 is a perspective view of an elevator system having a traction drive in accordance with the present invention.

FIG. 2 is a sectional side view of the fraction drive, showing a tension member and a sheave.

FIG. 3 is a perspective view of a drive in an elevator system illustrating a diverter or secondary sheave.

FIG. 4 is a perspective view of an elevator system illustrating the use of other sheaves.

### DETAILED DESCRIPTION

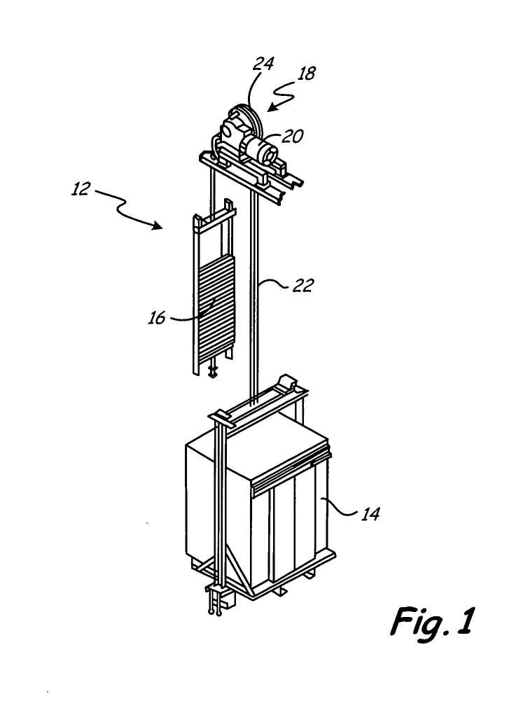

As shown in FIG. 1, a traction elevator system 12 includes a car 14, a counterweight 16, a fraction drive 18, and a machine or motor drive unit 20. The traction drive 18 includes a tension member 22, interconnecting the car 14 and the counterweight 16, and a traction sheave 24. Typically most sheaves are fabricated from cast iron, and currently Grade 40 cast iron is in use, which means that it has a strength of 40 KSI. This system as shown is a 1:1 rope system. The invention does not depend on the specific rope system but functions to repair sheave surfaces in any rope system, such as 2:1 rope systems and any other elevator system where sheaves and ropes or other tension members are employed.

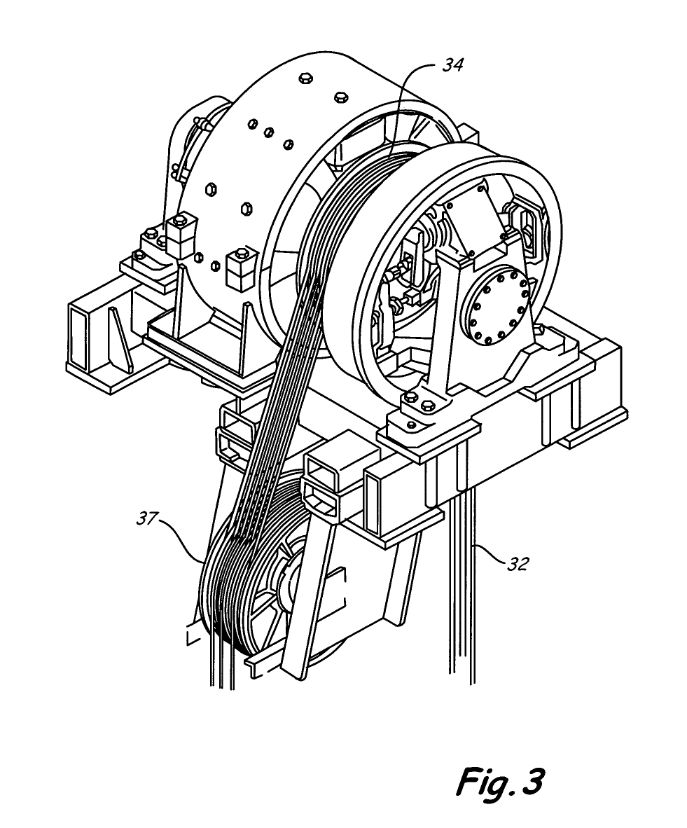

To achieve the desired arrangement of the ropes in the hoistway, the elevator system could include one or more deflector sheaves. The ropes engage the deflector sheave, but unlike the traction sheave do not drive the ropes. FIG. 3 illustrates deflector sheave 37 that functions to divert the path of tension member 32 that is driven by drive sheave 34.

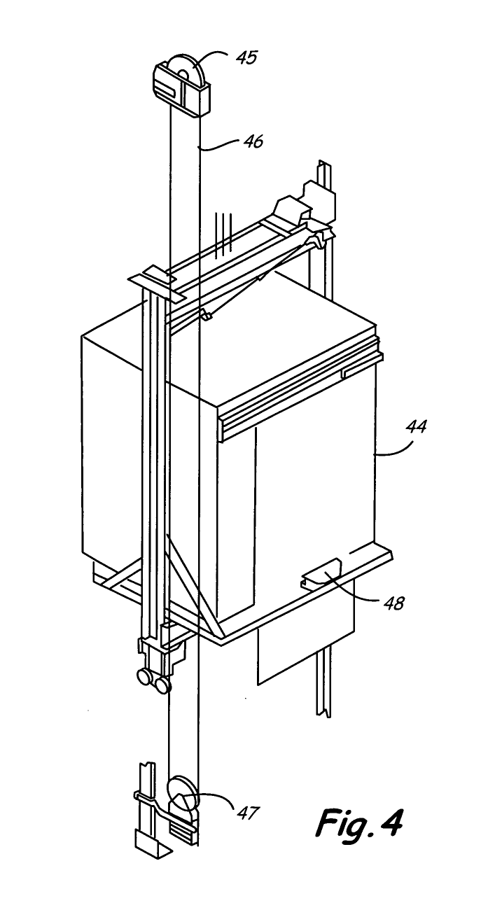

The elevator system can also include a safety system, as seen in FIG. 4, to ensure the car 44 does not exceed a predetermined limit. The safety system can include an overspeed governor and safeties. The overspeed governor includes a governor rope 46 extending the length of the hoistway, attached to a governor sheave 45 and a tensioner 47. If the speed of the car exceeds the predetermined limit, a centrifugal flyweight assembly driven by the governor sheave 45 would swing outwardly, tripping a switch thereby removing power to the elevator machine. If the speed of the car continues to increase, the flyweight assembly would swing outwardly still further and operate a governor brake. The governor brake would apply a frictional drag force to the governor rope 46, thereby actuating a pair of safety wedges 48 in communication with the governor rope 46. The safety wedges 48, attached to the elevator car 44, act on the elevator guide rails.

Since the sheaves can be used in a variety of shapes and sizes, depending on the specific use for which they are intended. Each has a predetermined shape and size for engagement with at least one rope or other friction element in the elevator system. It is to be understood that any sheave used in an elevator system for friction engagement with a friction element is within the scope of this invention.

As seen in FIG. 1, tension member 22 is engaged with the sheave 24 such that rotation of the sheave 24 moves the tension member 22, and thereby the car 14 and counterweight 16. The machine 20 is engaged with the sheave 24 to rotate the sheave 24. Although shown as a geared machine 20, it is noted that this configuration is for illustrative purposes only, and the present invention may be used with geared or gearless machines and with other elevator systems. All that is required is that there be a sheave and a friction element that engages the sheave.

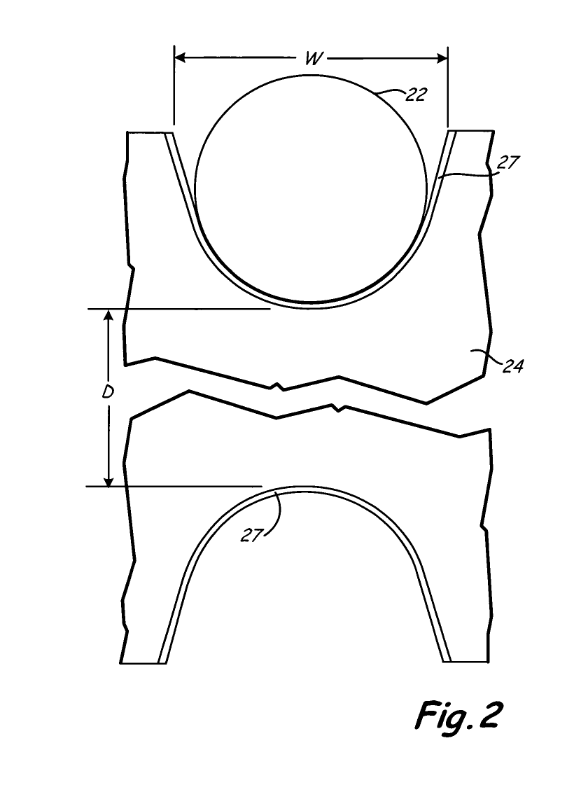

FIG. 2 shows the tension member 22 and the sheave 24 in more detail. Sheaves such as sheave 24 have traditionally been made from cast iron, and have had adequate wear and resistance to friction losses in smaller system. The tension member shown is a single rope. Other tension members are formed from a plurality of twisted strands, each made up of metallic wires. Still other tension members are also contemplated, since elevator systems include a variety of ropes and other friction elements that contact sheaves. All that is necessary is that the tension member frictionally engage the sheave 24. It should be noted that the sheave 24 is shown as separate parts because the minimum ratio of the diameter of a sheave and a rope is 40:1.

Sheave 24 is shown with a coating 27 that has been applied to it in the region where the tension member 22 engages the sheave 24. The thickness of coating 27 is shown larger than in actual practice to illustrate its relationship to the sheave 24 and tension member 22. The sheave 24 has a predetermined width and diameter prior to having coating 27 applied to it, and after coating, as shown in FIG. 2, the width W and diameter D are, within tolerances, the same as the specifications for a pro-coated sheave.

The wear coefficient of a sheave is essentially a measurement of the wear rate of the surface. In evaluating wear on surfaces, the volume of wear that is measured (V)mm³ is equal to the wear coefficient (K) mm²/n times the applied load (P) N (Newtons) times the sliding distance (D) mm. As a formula, this is V=K(PD), where V, K, P and D are defined as above.

Coating 27 may be any coating that reduces the wear coefficient of the region of sheave 24 in contact with the tension member 22. Cast iron Grade 40, which is a conventional material for sheave construction, has a wear coefficient K of about 1.03×10⁻⁹ mm²N. Preferred are wear coefficients of less than about 2.0×10⁻¹⁰ mm²N and more preferred are wear coefficients of less than about 1.0×10⁻¹⁰ mm²N. This translates into a wear coefficient that is about 20% of the wear coefficient of the uncoated sheave 24 (i.e., an 80% reduction in wear coefficient). Preferred is a reduction of the wear coefficient by about 15%, and most preferred is a reduction in wear coefficient by about 10% from the wear coefficient of an uncoated sheave. The range of 80% to 90% reduction has been found to significantly improve the life of the sheave and of the ropes or other friction elements that are in contact with such a coating.

A wide variety of coatings may be used with the present invention. Examples, by way of example and not as a limitation, include pure metal powders such as aluminum, cobalt, copper, iron, molybdenum, nickel, silicon, and titanium. Metal alloy powders include alloys of two or more elements selected from aluminum, cobalt, copper, nickel, molybdenum, and iron. Metal carbide powders include chromium carbide and tungsten carbide. Ceramic oxide powders include aluminum oxide, chromium oxide, titanium oxide, and zirconium oxide. Metal wires include aluminum, cobalt, copper, iron, nickel, molybdenum, titanium and alloy wires of two or more elements selected from aluminum, cobalt, copper, nickel, molybdenum, silicon and iron, as well as wires containing chromium carbide and tungsten carbide.

Coatings could be selected from the group consisting of cobalt alloys having a chromium component, molybdenum, cobalt phosphorus and nickel tungsten alloys. An exemplary cobalt alloy has a trade designation of Stellite 6, and has a composition by wt% of about 27% chromium, 4% tungsten, 3% iron and 3% nickel, and 1% silicon and 1% carbon. Molybdenum is an element and not an alloy. Cobalt phosphorous is a cobalt alloy with by wt% 4% to 6% phosphorous. Nickel tungsten alloys have about by wt% 65% nickel and 35% tungsten.

The coatings may be applied in a variety of ways. All that is necessary is to apply the material, whether a metal or an alloy or other material, to the intended surface to permit the material to densify and bond to the sheave surface. High velocity oxygen fuel spray, plasma spray, cold spray, arc-wire, laser cladding and electroplating methods are all effective coating methods. Once the coating has been applied, it can be fused by applying additional heat, or that step can be omitted.

The coating can range in thickness from about 0.1 mm to 1.25 mm, with a thinner coating being less expensive in material cost and processing cost. More preferred is a range of about 0.125 mm to about 1.0 mm, and most preferred is from about 0.15 mm to about 0.75 mm.

A number of materials were evaluated as coatings for sheaves in accordance with the present invention. The wear coefficient K mm²=V mm³/(P N×D mm) is determined by measuring the volume V in cubic millimeters of wear debris from the sheave surface as it is subjected to a load in Newtons (N) over a distance in millimeters. Tests were run on various coatings using a first load of 444 Newtons over a span of 8.9 mm over a single day of testing. Other tests at 222 Newtons and 666 Newtons were made on selected coatings Presented below in Table I are the results of some of tests showing a significant improvement in the wear coefficient K in mm²n as noted above.

TABLE I

| | WEAR COEFFICIENT | ROPE WEAR COEFFICIENT |
|---|---|---|
| SHEAVE COATING | K mm² N = Vmm³/(P n × D mm) | K mm² N = Vmm³/(P n × D mm) |
| Cast Iron Grade 40 (control) | 1.03 × 10⁻⁹ | 1.37 × 10⁻⁹ |
| Cobalt Chrome alloy | 1.87 × 10⁻¹⁰ | 5.01 × 10⁻¹⁰ |
| Molybdenum | 1.37 × 10⁻¹⁰ | 4.73 × 10⁻¹⁰ |
| Cobalt Phosphorous | 0.81 × 10⁻¹⁰ | 5.71 × 10⁻¹⁰ |
| Nickel-Tungsten | 1.19 × 10⁻¹⁰ | 1.33 × 10⁻¹⁰ |

As can be seen from the data in Table I, the four coatings that were tested reduced the coefficient of wear of the sheave significantly and also resulted in improved wear on the ropes when compared to the same rope used on an uncoated sheave. In some cases the sheave wear coefficient improved to a value less than 18.2% to as low as 6.25% of the control wear coefficient. The rope wear coefficient improvement ranged from 41.7% to 9.7% of the wear coefficient compared to the control.

Although the present invention has been described with reference to preferred embodiments, workers skilled in the art will recognize that changes may be made in form and detail without departing from the spirit and scope of the invention.

1. A coated elevator system component that interacts with a friction component, the coating component comprising:
a body having a predetermined shape and size for engagement with at least one friction element in the elevator system; and
a coating on the body having a wear coefficient of less than 2.0×10⁻¹⁰ mm²N.

2. The coating of claim 1, wherein the wear coefficient on the coated body is less than 1.0×10⁻¹⁰ mm²N.

3. The coating of claim 2, wherein the wear coefficient of the coated body is less than 20% of the wear coefficient of the body without a coating.

4. The coating of claim 1, wherein the coating is selected from the group consisting of cobalt alloys having a chromium component, molybdenum, cobalt phosphorus and nickel tungsten alloys.

5. The coating of, claim 1, wherein the thickness of the coating on the body ranges from about 0.1 mm to about 1.25 mm.

6. The coating of claim 5, wherein the thickness of the coating ranges from about 0.125 mm to about 1.0 mm.

7. The coating of claim 1, wherein the coating is a fused coating.

8. The coating of claim 1, wherein the sheave is selected from a governor sheave, traction sheave, deflector sheave and a safety wedge.

9. The coated sheave of claim 1, wherein the sheave is cast iron.

10. The coated sheave of claim 1, wherein the wear coefficient on the sheave is about 10% of the wear coefficient of the sheave without a coating.

11. A coated elevator system component that interacts with a friction component, the coating component comprising:
a component body having a predetermined shape and size for engagement with at least one rope in the elevator system; and
a coating on the body selected from the group consisting of cobalt alloys and having a chromium component, molybdenum, cobalt phosphorus and nickel tungsten alloys, the coating having a wear coefficient on the sheave of less than 2.0×10⁻¹⁰ mm²N, the coating and body being sized to maintain the predetermined shape and size.

12. The coated body of claim 11, wherein the coating is a fused coating.

13. The coated body of claim 11, wherein the thickness of the coating ranges from about 0.1 mm to about 1.25 mm.

14. The coated sheave of claim 11, wherein the body is selected from a governor sheave, traction sheave, idler sheave and a safety wedge, and wherein the thickness of the coating ranges from about 0.125 mm to about 1.0 mm.

15. The coated sheave of claim 17, wherein the sheave is cast iron.
